(19) United States
(12) Patent Application Publication
(10) Pub. No.: US 2014/0083837 A1
(43) Pub. Date: Mar. 27, 2014

(54) SYSTEM FOR CONCENTRATING INDUSTRIAL PRODUCTS AND BY-PRODUCTS

(71) Applicant: Shaul Yaakoby, Rishon Le Zion (IL)

(72) Inventor: Shaul Yaakoby, Rishon Le Zion (IL)

(21) Appl. No.: 14/117,658

(22) PCT Filed: May 16, 2012
(86) PCT No.: PCT/IB12/52452

§ 371 Date: Nov. 14, 2013

(30) Foreign Application Priority Data
May 17, 2011 (GB) 1108198.1

(51) Int. Cl. A23L 2/08

(52) U.S. Cl. CPC A23L 2/08
USPC 202/197

(57) ABSTRACT

A system for the enrichment of at least one component in a source liquid containing at least two components intermixed. The system includes: a tower of superimposed subunits, the uppermost subunit being a vapor chamber; an intermediate subunit functioning as a heating chamber; and a lowest subunit functioning as a sedimentation chamber; a wall partially separating the vapor chamber from the heating chamber; at least one heating unit; at least one shutter at the bottom of the intermediate subunit disposed above the sedimentation chamber to facilitate release of sediments into the sedimentation chamber; an intermediate storage container for storing liquid at equilibrium pressure with the atmosphere; an inlet for refilling the intermediate subunit by pumping; and an outlet for releasing processed liquid from the uppermost vapor chamber to an external container.

### CROSS REFERENCE TO RELATED APPLICATIONS

This application is a national stage entry of International application PCT/IB2012/052452, entitled “System for concentrating industrial products and by-products” and filed on May 16, 2012, which claims priority from patent application GB 1108198.1, entitled “System for concentrating industrial products and by-products”, filed on May 17, 2011, the entire contents of which are incorporated herein by reference.

### FIELD OF THE INVENTION

The present invention relates to a system for distilling, purifying or desalinating source liquids.

### BACKGROUND OF THE INVENTION

Water is abundant on the earth, but the availability of good quality, contaminant free water is decreasing constantly. Not only is the consumption of water by household units, agriculture and industry on the rise, but available water is getting contaminated by natural and man-made pollutants, thus reflecting not only on the quantitative availability but also on the qualitative aspects of availability of water. Implementing methods for acquiring good quality water is becoming a necessity in more and more countries around the globe. The present invention offers a scheme for using many kinds of existing available energy sources for the production of good quality water, from a variety of sources. In addition, a variety of liquid mixtures can be processed in a system as described hereinbelow to enrich one or more components of the original liquid and also in some applications separate one of the constituents of that mixture and make further use of it.

### SUMMARY OF THE INVENTION

In accordance with embodiments of the invention, there is provided a system for the enrichment of at least one component in a source liquid containing at least two components intermixed, the system comprising a tower of superimposed subunits, the uppermost subunit being a vapor chamber; an intermediate subunit functioning as a heating chamber; and a lowest subunit functioning as a sedimentation chamber. The system further comprises a wall partially separating the vapor chamber from the heating chamber; at least one heating unit; at least one shutter at the bottom of the intermediate subunit disposed above the sedimentation chamber to facilitate release of sediments into the sedimentation chamber; an intermediate storage container for storing liquid at equilibrium pressure with the atmosphere; an inlet for refilling the intermediate subunit by pumping; and an outlet for releasing processed liquid from the uppermost vapor chamber to an external container.

### BRIEF DESCRIPTION OF THE DRAWINGS

FIG. 1 is a schematic depiction of the relationship between the input and outputs of the overall process of the present invention;

FIG. 2 is a schematic depiction of the primary events taking place in the process of the present invention;

FIG. 3 is an isometric schematic external view of an embodiment of a system of the present invention showing compartments thereof;

FIG. 4 is an isometric schematic external view of the present system showing compartments and a sediment extraction port thereof;

FIG. 5 is a cross sectional view of the present system, showing the structural relationships between a vapor chamber and the heating chamber thereof;

FIG. 6 is a cross sectional view of the present system showing the structural relationships between the vapor chamber and a heating chamber, showing the respective outlets thereof;

FIG. 7 is a block diagram showing the position of a filtering element of the present system, in a functional context;

FIG. 8 is a schematic depiction of the mass transfer of matter taking place inside the system of the invention, between chambers thereof;

FIG. 9 is a schematic depiction of the system of the present invention, indicating the routing of liquid and sediments and some limiting aspects thereof;

FIG. 10 is a schematic description of mass transfer taking place inside-out and outside-in of a system of the present invention;

FIG. 11A is a schematic depiction of the course energy/heat flow within the compartments of a generalized system of the invention;

FIG. 11B is a schematic depiction of the course energy/heat flow within the compartments of the system of the invention deriving heat from a heat source; and

FIG. 12 is a cross sectional view of a chimney top implementing an effluent cleansing set-up of the invention.

### DETAILED DESCRIPTION OF THE INVENTION

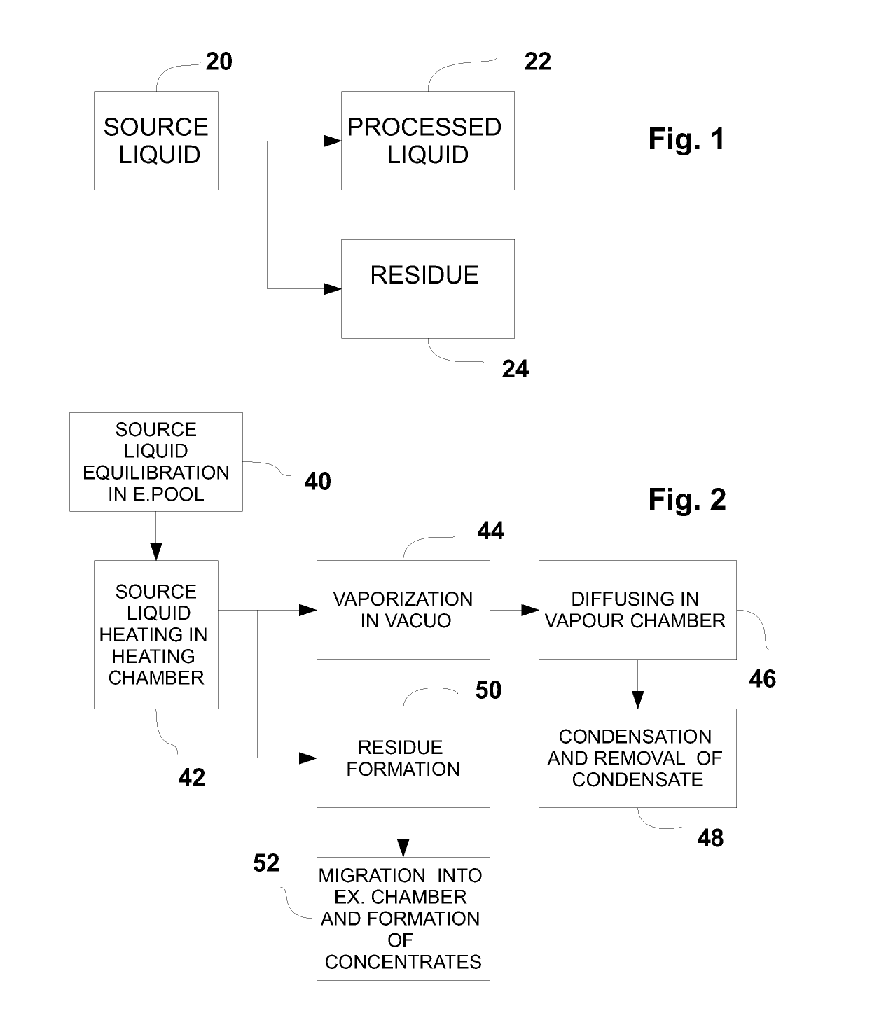

In most general terms and with reference to FIG. 1, source liquid 20 undergoing a process in accordance with the present invention provides two products: processed liquid such as water 22 and residue 24 In accordance with the present invention, source liquid such as water containing soluble materials, and/or dispersed materials is cleaned or purified by processing the source liquid, passing its vapor phase through a compartment containing gas and possibly vapor under partial vacuum, and collecting the processed liquid in a separate container, while the contaminants are collected via an extraction chamber. The gaseous contents under partial vacuum act in this case as a semi permeable membrane, which has a complete or partial preference for one of the constituents of the source liquid. A practical difference between the selectivity of a filter and that of the partial vacuum is that the liquid needs to be vaporized in order to undergo filtration in order to selectively enrich one or more of the constituents. On the other hand the partial vacuum does not have to be maintained or replaced, like physical filters.

The compartments, and process through which the source liquid undergoes, are described in more detail with reference to FIG. 2. The term source liquid referred to in the present document, relates also to a variety of aqueous liquids found as natural resources, such as sea water, brine, underground water, lake water, river and so on, whether contaminated by human refuse or uncontaminated. In addition the term also relates to aqueous or non aqueous liquid resources originating as human artifacts, such as sewage, industrial or domestic, and processed water emanating from a variety of industrial plants.

In FIG. 2 the main steps implementable using the system of the present invention is shown. In step 40 source liquid is brought to a pressure equilibration pool or container, open to the ambient atmosphere, and in which some cleaning can take place, such as by sedimentation of particles. From the equilibration pool, liquid is pumped to a heating chamber in step 42, from the surface of the liquid in which liquid vapor arise, filling a spacious vapor chamber located right above the heating chamber in step 44, as will be explained separately in more detail below. In the vapor chamber, the warm vapor diffuses at step 46 and fills the available space. In step 48, some of the vapor gets condensed forming liquid which is removed to be utilized as high quality product, such as distilled water. In parallel to the vaporization, residue may be formed in the heating chamber in step 50. This residue forms as salt crystals, or dispersed material is removed from as a result of heating and rise in concentration of contaminants. However, the residue formed migrates by gravitational force into an extraction chamber located right below the heating chamber in which the residue accumulates, forming concentrates, at step 52.

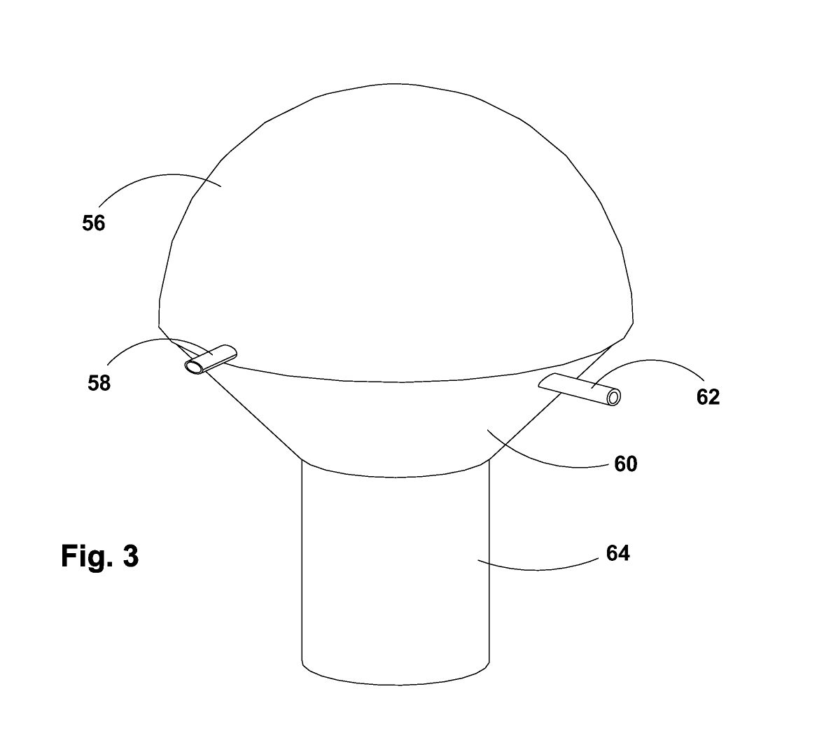

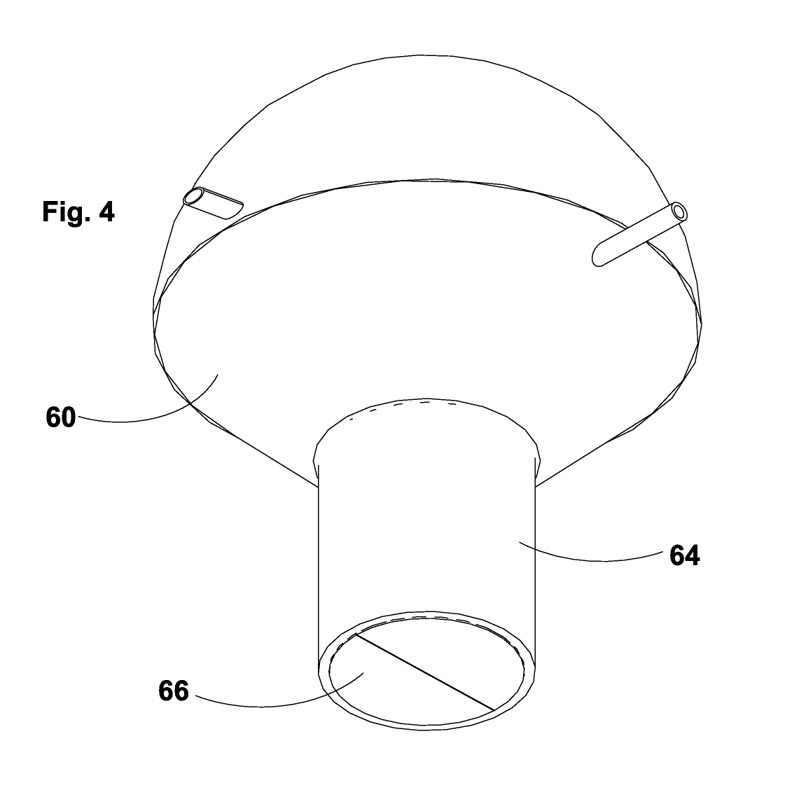

Significant features of the structure of a device, in which the present system is implemented, are discussed next. The vapor chamber is a container in which vapors arising from the surface of the liquid at a heating chamber are condensed. To explain this important aspect, reference is first made to FIG. 3. In vapor chamber 56 of a liquid processing device of the system of the present invention, liquid outlet 58 is installed, which draws processed liquid from the base of the vapor chamber. Right beneath the vapor chamber, heating chamber 60 contains pre-processed liquid. Inlet 62 refills the heating chamber with pre-processed liquid keeping the level of pre-processed liquid in heating chamber 60 at an appropriate level. Sedimentation chamber 64 is a part of the liquid processing device in which the residue originating from the source (pre-processed) liquid is extracted. In FIG. 4, the liquid processing device is seen from below demonstrating sedimentation chamber 64 and sediment extraction port 66.

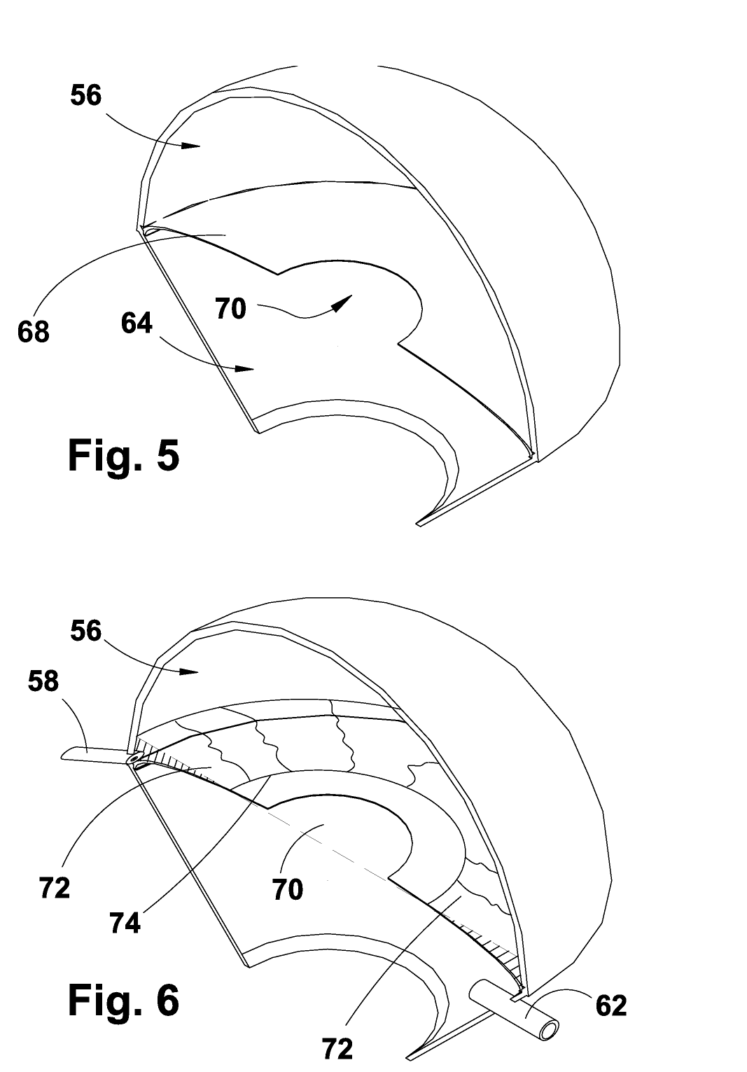

FIG. 5 shows a cross section of the system described above (without the sedimentation chamber). A two tier compartmentalized arrangement partially secludes vapor chamber 56 from heating chamber 60 by a separating wall 68. The separating wall is incomplete and a median aperture 70 facilitates vapor formed in the lower tier, i.e. heating chamber 60 to the upper chamber, i.e. vapor chamber 56. Thus, the pressure in the heating chamber is equal to the pressure in the vapor chamber. Condensed liquid accumulates mostly on separating wall 68 which is shaped in such a way that a certain body of liquid is accumulated and can be removed by a conduit to a further storage place.

To describe the path that the liquid flows once condensed, reference is made to FIG. 6. Accumulated condensed liquid 72 resides at the bottom of vapor chamber 56 due to a condensation process taking place in the condensation chamber. The level of this body of liquid reaches as far inside as circle 74, the system taking care that no liquid reaches the median aperture 70, lest liquid falls down to the lower compartment. Outlet 58 is a means for transferring the condensed liquid from the bottom of the condensation chamber to a successive storage means, prior to disseminating to users.

Principles of Operation

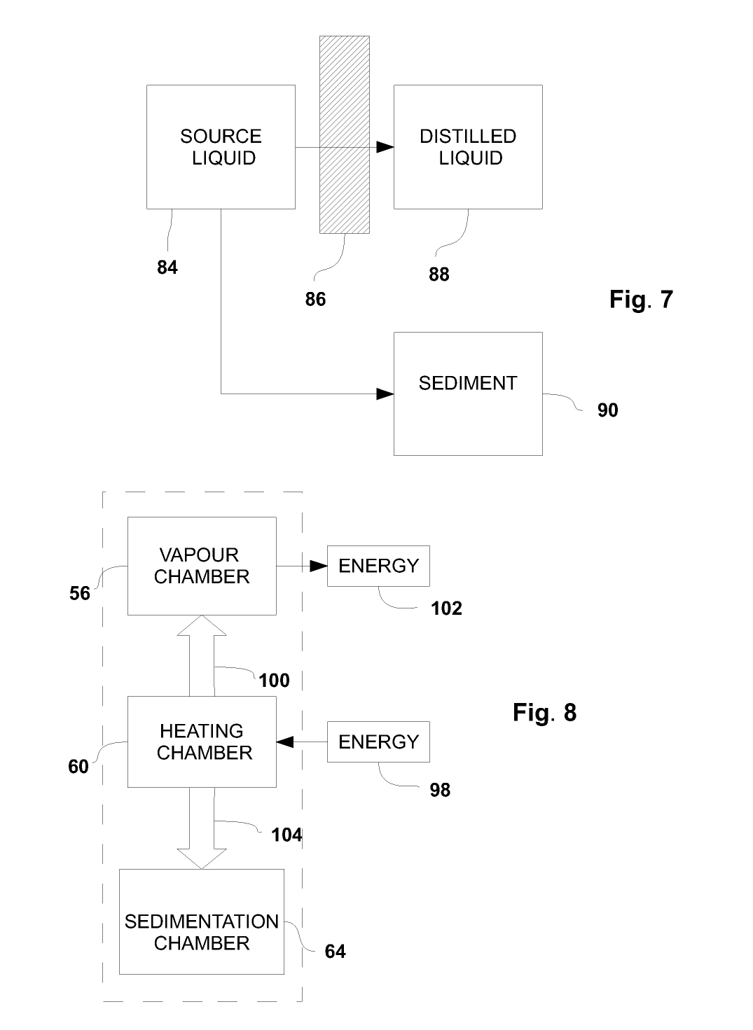

A filter in the form of void under partial vacuum divides between the source liquid and the processed liquid. As can be seen in FIG. 7, source liquid 84, typically under atmospheric pressure, passes through filter 86 and proceeds to its distilled form 88. Sediment 90 does not pass through the filter, but owing to a different aspect of the process of the invention, the soluble and other contaminants either separate to settle down as sediments or form a brine, as will be discussed below. In order to separate the liquid from the dispersed/dissolved matter contained therein, energy must be furnished to drive the process. This energy is obtained from a heating module that energizes the source liquid in the heating chamber, turning a portion of the source liquid into vapor. As can be seen schematically in FIG. 8, energy 98 is supplied to heating chamber 60 which causes a mass of liquid 100 to convert to vapor and move to vapor chamber 56 where energy 102 is removed and the vapor, or at least a portion of it, condenses.

While the source liquid is heated and a portion of it vaporises, some of the dissolved or dispersed contaminants aggregate, solidify or otherwise concentrate, for example the minerals in the water may form a residue merely as a result of the heating. However, the removal of liquid vapor from a given amount of source liquid or the eventual gradual concentration of the liquid in the heating chamber, drives the mass of contaminants 104 or at least a part of them out of the liquid and thereby the contaminants lighter than the liquid eventually sink into sedimentation chamber 64.

Loading and Unloading the System

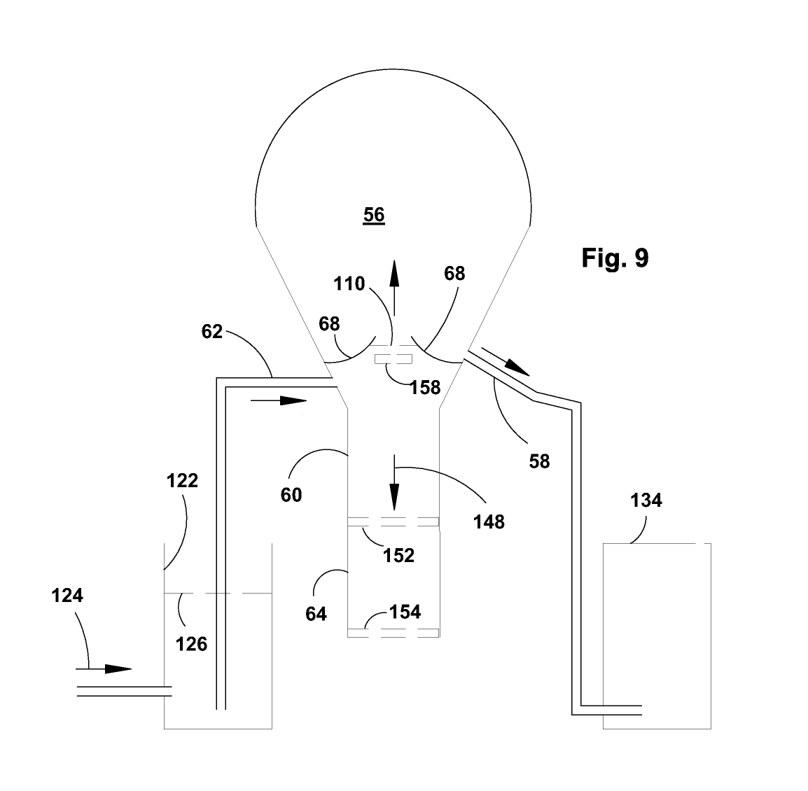

In an embodiment of the system of the invention, described with reference to FIG. 9, source liquid, such as sea water is first pumped into intermediate container 122 into which water is brought from the source location, as indicated by arrow 124. In container 122, water pressure is equilibrated with atmospheric pressure, and a primary cleaning step can take place by letting sediment precipitate on the floor of the container. Liquid from container 122 typically form a continuum with the liquid in heating chamber 60. Liquid level 126 can be maintained at a specific equilibrium with the liquid in chamber 60, in order to keep liquid upper surface 110 at a specific level, the liquid level 126 in container 122. The higher the liquid level 126, the higher level of liquid upper surface 110 can be, the exact difference in height depending on other factors, such as the vacuum in chamber 56. Processed liquid, i.e. high quality or distilled liquid accumulates at the bottom of chamber 56, separated from the liquid at chamber 60 by separating wall 68. The exact structure of separating wall 68 determines how much processed liquid can be stored in chamber 56 before it is to be despatched to container 134 through piping 58.

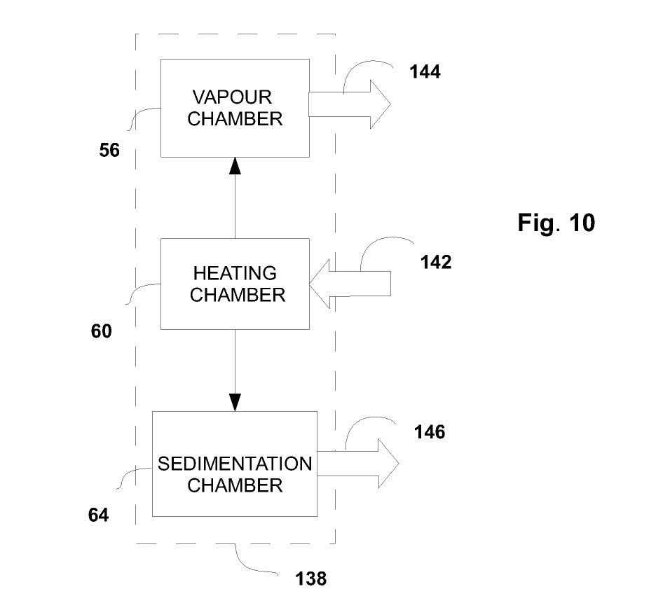

In FIG. 10, the system of the invention as is schematically depicted. Tower 138 includes three serially superimposed subunits, separable at least to some extent. Vapor chamber 56 is the one situated on top, under it heating chamber 60 is located, and lowermost sedimentation chamber 64 is located. Mass transport into and outside of the system is shown by arrows as follows: arrow 142 indicates the mass of source liquid entering the system, arrow 144 indicates the mass of processed, high quality liquid leaving the system and arrow 146 indicates the sediment mass leaving the system as will be described in more detail below.

The sediments or brine or any other concentrated solid or liquid, that may form in heating chamber 60 as a result of heating or loss of lighter components to the upper chamber, are typically of higher weight than the source liquid and therefore should sink or precipitate to the bottom of chamber 60, in the direction of arrow 148. At the bottom of chamber 60, an upper shutter 152, when kept open, allows sediments and brine to precipitate into chamber 64. When appropriate, a lower shutter 154 can be opened while upper shutter 152 is closed, to unload the sediments/brine, while the main process continues in the upper chambers.

Energy Flow and Heat Considerations

In order to control the throughput and maintainability of the present system, some parameters are to be taken into consideration. A vacuum in the heating/vapor chambers should decrease the temperature of boiling of the source liquid, however, maintaining a vacuum is energy consuming. There are two ways of forming a vacuum as required in the implementation of the present invention. The first is by way of Torricelli's vacuum, in which the liquid is pumped to a certain height in a closed conduit system, and the gravity applied on the liquid pulls a portion of the liquid causing a partial vacuum to form on the top of the upper level of the liquid column. In another approach, a vacuum pump is connected to the vapor chamber. In order to produce a partial vacuum in the vapor chamber, as can be seen in FIG. 9, heating elements 158 are located near the upper surface 110 of the source liquid in the heating chamber. To cool the vapor in the vapor chamber in order to bring about condensation, active appliances in the form of heat exchangers are to be inserted in the vapor chamber. Passive heat dissipating elements such as cooling fins can be attached to the vapor chamber externally, to increase the heat flow taking place from the heated up vapor chamber to the environment.

A reason for keeping the boiling temperature low is to prevent or lower the heat induced scale formation on various parts of the system associated with heating in the heating chamber. It is suggested that keeping the boiling temperature low would favour formation of sediment in the liquid rather than the formation of scale adhering to heat exchange elements or any other heated object.

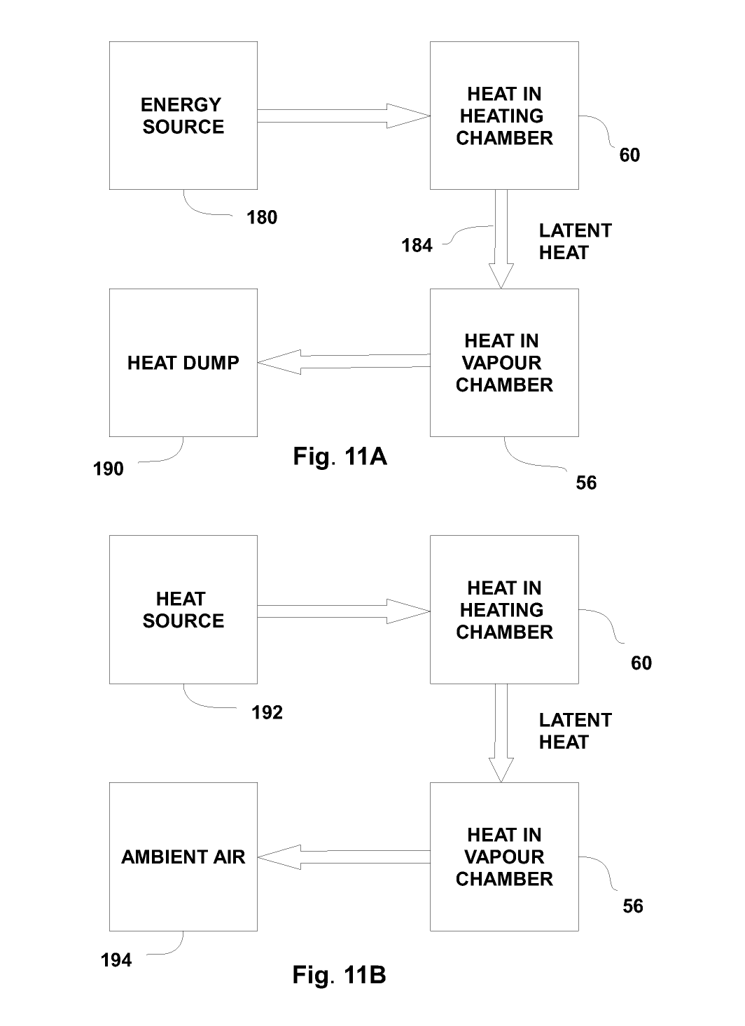

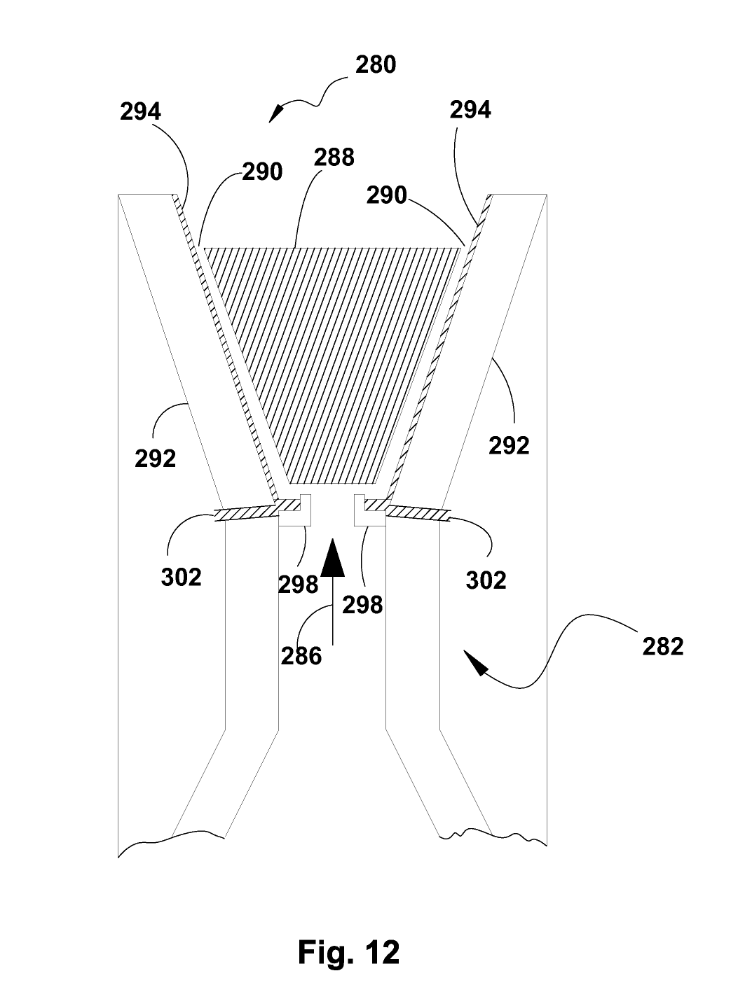

Referring now to FIGS. 11A-B, The heat transfer in the system of the invention is described. First, generally in FIG. 11A, energy source 180 supplies power, such as in the form of electric current, to produce heat in heating chamber 60, for the purpose of changing the phase of the liquid to vapor. Latent heat is transported together with the vapor as symbolized by arrow 184. In vapor chamber 56 the heat is pumped by a heat pump to a heat sink 190. In a particular example of a utilization of an embodiment of the invention, the energy source for elevating the temperature of the liquid (typically water) in the heating chamber, is derived from the heat existing in the base of a chimney. The heat is collected by a metal hose wrapped around the base of a chimney. The whole process in this example is explained with reference to FIG. 11B. Heat is pumped from heat source 192, in this case a chimney, a part of it is passed on to the liquid in heating chamber 60. Subsequently the heat passes in the form of latent heat to vapor chamber 56 to be released there by the condensation of the vapor. A heat pump releases the heat, typically into the ambient air 194.

Control of the Liquid Level Inside the Heating Chamber

There are many dynamic physical factors that determine the level of the liquid inside the heating chamber. For example barometric pressure that pressurizes the liquid in open vessels, the density of the liquid inside the heating chamber, and actual pressure inside the vapor chamber. Calculating the level of the liquid inside the heating chamber would be a complicated task relying on the data that is to be obtained from several sensors. It would seem beneficial therefore that a direct automatic control of the level of the liquid in the heating chamber is exercised by applying a liquid level sensor and a en electronic closed loop control that would set the level at a specific state, typically predetermined, A liquid level sensor, such as ultrasonic liquid level detector, or any other available implement that is adapted to endure the dampness and somewhat high temperatures prevailing inside the chambers, are applicable. Additionally, a porthole or a window for visually inspecting the contents and state of the inside of the chambers (heating and vapor) may be provided along with a dedicated lighting element, if required.

Environmental Benefits of Implementing the Present Invention

As described above, energy for the transition of liquid from the liquid phase to the vapor phase may be obtained from conventional sources such as electric power carried over power lines or produced locally by generators. In a more environmentally considerate way, heat can be drawn from existing heat sources such as chimneys, heat exchangers in industrial applications, geothermal energy, solar energy, wind energy, and used for the purpose heating the source liquid in the heating chamber.

Implementing the Present System for the Production of Solid Products

Liquid or in general liquids from natural or industrial resources usually contain varying amounts of dissolved or suspended material. Filling the heating chamber with source liquid, can be used concomitantly to evaporate the solvent (such as water, brine or oil) in order to obtain an enriched product, and on the other hand sediments can form as explained above which can precipitate into the sedimentation chamber. In a suitable time the sediments can be collected from the sediment chamber and further processed or packaged.

Implementing the Present System for Collecting Chimney Exhaust

A further exemplary industrial application of the present invention, concerns the collection of chimney effluents. The collection is performed in a certain way, as depicted in FIG. 12. The shaft of chimney top 280 typically includes a constriction 282. Further above, the lining of the shaft widens forming a funnel shaped structure. Arrow 286 marks the direction in which the effluents move through the chimney. Between conical plug 288 and the lining of the chimney shaft there exists narrow gap 290. The slanted wall 292 has an internally looking face 294 the lining of which is covered with a layer of streaming water. Preferably also the face of plug 288 is also covered with streaming water. Water dripping or streaming from slanted wall 292 or also from the face of plug 288 is collected at trough 298, and removed through conduits 302. The number, size and slant angle of such conduits is a practical issue. The liquid collected and flowing through conduits 302 is than pumped to container/s such as container 122 in FIG. 9. The water including dissolved and or dispersed matter collected from the chimney top as described above can be separated into water and sediments as described with reference to FIGS. 5,6,7,8 and 9, so that the dispersed matter excluded from the chimney's effluent can be salvaged while the water purified. The purified water may be used again to be applied at the chimney top to flow linearly or in a spiralling motion around plug and or lining of the slanted wall. As an example, for power stations burning sulphur contaminated fuel, the SO2 resulting from the combustion turns into sulphuric acid when dissolving in the water at the chimney top. Implementing the system of the invention for such an application, the effect of concentrating can be used to receive through the sedimentation chamber a more concentrated sulphuric acid than in the solution obtained at the chimney top. The concentration aspect can be quite useful in several industrial applications.

Applications in the Food Industry

Fruit and vegetable juices are obtained from the plants in a typically lower concentration of dissolved components as favourable. In order to increase the concentration, a system as described above can be used. For example, citrus juice of freshly harvested fruit is fed into a heating chamber of a device as shown in FIG. 9. Gentle heating is applied in the processing in order to preserve certain elements in the product.

What is claimed is:

1. A system for the enrichment of at least one component in a source liquid containing at least two components intermixed, the system comprising:
a tower of superimposed subunits, the uppermost subunit being a vapor chamber adapted for functioning under vacuum;
an intermediate subunit functioning as a heating chamber; and a lowest subunit functioning as a sedimentation chamber;
a wall partially separating the vapor chamber from the heating chamber;
at least one heating unit;
at least one shutter at the bottom of the intermediate subunit disposed above the sedimentation chamber to facilitate release of sediments into the sedimentation chamber;
an intermediate storage container for storing liquid at equilibrium pressure with the atmosphere;
an inlet for refilling the intermediate subunit by pumping; and
an outlet for releasing processed liquid from the uppermost vapor chamber to an external container.

2. The system of claim 1, wherein the source liquid is fruit juice and wherein a product of the enrichment is a concentrate.

3. The system of claim 1, wherein the pressure in the uppermost chamber and the intermediate subunit are substantially equal.

4. The system of claim 1, wherein gaseous contents of the uppermost and intermediate subunits under partial vacuum selectively enrich at least one of the contents of said source liquid.

5. The system of claim 1, wherein the lowest subunit contains both a sediment and a concentrate of the source liquid.

6. The system as in claim 1 wherein said heating unit is a heat pump (page 7 lines 22-22).

7. The system as in claim 1 that in order to bring about condensation at least one active appliance unit is inserted in said vapour chamber.

8. The system as in claim 7 wherein said active appliance is a heat pump.
